(19) United States
(12) Patent Application Publication
(10) Pub. No.: US 2026/0243888 A1
(43) Pub. Date: Aug. 20, 2026

(54) A METHOD FOR PROVIDING FALSE ALERT INFORMATION FOR DETECTIONS OBTAINED BY PERFORMING AT LEAST ONE RADAR MEASUREMENT

(71) Applicant: Valeo Schalter und Sensoren GmbH, Bietigheim-Bissingen (DE)

(72) Inventors: Anamika Yadav, Bietigheim-Bissingen (DE); Deepak Joshi, Bietigheim-Bissingen (DE); Leen Sit, Bietigheim-Bissingen (DE); Christian Sturm, Bietigheim-Bissingen (DE)

(73) Assignee: Valeo Schalter und Sensoren GmbH, Bietigheim-Bissingen (DE)

(21) Appl. No.: 19/161,519

(22) PCT Filed: Feb. 28, 2024
(86) PCT No.: PCT/EP2024/055042

§ 371 Date: Sep. 2, 2025

(30) Foreign Application Priority Data
Mar. 1, 2023 (DE) 10 2023 105 035.4

(51) Int. Cl. G01S 13/931; G01S 13/58

(52) U.S. Cl. CPC G01S 13/931; G01S 13/58

(57) ABSTRACT

Described is a method for providing false alert information for detections obtained by performing a radar measurement using a radar system. A false alert probability is determined by use of respective detection data sets of the detections. The respective detection data set of each detection comprises three position values characterizing a position in a three-dimensional field of view of the radar system, a power value characterizing a power of received signals of the respective detection, and a Doppler value. A two-dimensional window is defined in a domain described by two of the three position values of the detection data sets. For a part of the detections whose respective two position values are within the two-dimensional window, a respective false alert probability is determined based on the position values, Doppler values, and power values.

### TECHNICAL FIELD

The invention relates to a method for providing false alert information for detections obtained by performing at least one radar measurement using at least one radar system, in particular at least one radar system of a vehicle, in particular at least one 4D radar system.

Further, the invention relates to a method for detection of targets by use of at least one radar system, in particular at least one 4D radar system, in particular at least one radar system of a vehicle,
wherein at least one radar measurement is performed in which radar signals are transmitted and echo signals are received and converted into received signals,
detection data for detections are determined by use of at least a part of the received signals,
a method for providing false alert information for at least a part of the detections is performed.

Furthermore, the invention relates to a radar system, in particular a 4D radar system, in particular a radar system for vehicles, with means for performing a method for providing false alert information for detections obtained by radar measurements with the radar system.

Moreover, the invention relates to a driver assistance system comprising at least one radar system, in particular at least one 4D radar system, and comprising means for performing a method for providing false alert information for detections obtained by radar measurements with the at least one radar system.

Further, the invention relates to a vehicle comprising at least one radar system, in particular at least one 4D radar system, and comprising means for performing a method for providing false alert information for detections obtained by radar measurements with the at least one radar system.

### STATE OF TECHNOLOGY

From the CN 113671459 A a constant false alarm detection method for an FMCW radar moving target is known. The method adopts a constant false alarm algorithm based on random sampling to realize the estimation of FMCW radar background noise and the detection of target constant false alarm; the method eliminates window design and window sliding of a conventional constant false alarm algorithm, and realizes the overall noise estimation of the current RDM domain by sampling the whole RDM detection domain; meanwhile, the sliding operation of a two-dimensional window is avoided, the detection efficiency is improved, and the time complexity of the algorithm is greatly reduced.

It is an objective of the invention to provide a method for providing false alert information, a method for detection of targets, a radar system, a driver assistance system and a vehicle, where the providing of false alert information for detections obtained by performing radar measurements can be improved.

### DISCLOSURE OF INVENTION

The objective of the invention is achieved with the method for providing false alert information in that,
for at least a part of the detections each a false alert probability is determined as a false alert information by use of respective detection data sets of the detections,
wherein the respective detection data set of each detection comprises three position values characterizing a position in a three-dimensional field of view of the radar system, a power value characterizing an power of received signals of the respective detection and a Doppler value,
wherein with the method
at least one two-dimensional window is defined in a domain described by two of the three position values of the detection data sets,
for at least a part of the detections whose respective two position values corresponding to the domain having the window are within the at least one window, a respective false alert probability is determined based on the position values, Doppler values and power values at least of the part of the detections within the window.

According to the invention, at least a part of the detections which are within a two-dimensional window in a domain of two of three position values are considered for obtaining false alerts probabilities for the respective detections. In this way, the false alerts probability per detection based on its neighboring detections can be determined.

Advantageously, the method for providing false alert probability can be processed after at least one radar measurement. In this way, the datasets obtained with the radar measurement can be processed time independent from the radar measurement.

Advantageously, the detections can be obtained with a 4D radar system. A 4D radar system detection can be used to obtain data sets with four dimensions described by three position values and one Doppler value. According to the invention, false alert information can be performed for all four dimensions, the three position dimensions and the one Doppler dimension.

The respective detection data set of each detection comprises three position values characterizing a position in a three-dimensional field of view of the radar system. Advantageously, two of the position values can characterize angles, in particular azimuth and elevation, and one of the position values can characterize a range. In this way, each detection can be specified with values characterizing spherical coordinates.

The Doppler value can be used characterize a velocity, in particular radial velocity, of a target relative to the radar system or relative to a predefined reference system.

Advantageously, the position values and the Doppler values can indicate so-called bins, in particular azimuth bins, elevation bins and Doppler bins or bins characterized by more of one of the values. In this way, it is easier to assign the detections. Advantageously, the position values can be azimuth values, elevation values and range values. Advantageously, the two-dimensional window can be defined in the azimuth-range domain or in the elevation-range domain.

During a radar measurement at least one electromagnetic radar signal is transmitted from at least one transmit antenna element of the radar system into the respective monitoring area. At least one electromagnetic echo signal resulting from at least one radar signal reflected from at least one target in the field of view of the radar system is received by at least one receiving antenna element. The received at least one echo signal is converted into received data. The received data can be suitable for signal processing, in particular for electronic signal processing.

Depending on the means for signal processing, the received data may include electrical signals or electrical values, for example based on digital values like bits. In this way, the received data can be processed by electrical means for signal processing. Additionally or alternatively, the received data may include optical signals or values, for example based on qubits. In this way, the received data can be processed by optical means for signal processing, for example, quantum processors.

With the at least one radar system position data, in particular direction data and range data, Doppler data and/or power data that characterize positions, in particular directions and ranges, relative velocities or a reflection behavior of detected targets relative to the radar system and/or relative to the host vehicle, can be obtained. The respective data may include or consist of respective values, in particular position values like azimuth, elevation and/or range, Doppler values and power values.

A target in the sense of the invention is an area or a reflection point of an object from which radar signals can be reflected. An object can have one or more such targets. If the object has several targets, radar signals can also be reflected differently from these, for example in different directions. Targets detected with the radar system may be referred to as “detected targets” for easier distinction.

A detection in the sense of the invention is a signal on the receiving side of the radar system. A detection may be caused by echo signals reflected from targets. Detections also may be caused at least in part by noise. Thus, not every detection necessarily gives information about a target in the field of view of the radar system. Detections that are not caused by reflected echo signals are so-called “false alerts”. The method according to invention can provide false alert probabilities for the detections.

Advantageously, the radar system can be realized as high-definition (HD) four-dimensional (4D) imaging radar. Autonomous driving can be improved with 4D radar systems in combination with driver assistance system. Thus, level 4 and level 5 autonomous driving systems can be realized. Advantageously, the radar system can be powered with a large antenna array of transmit and receive antennas. The radar system can be operated with a MIMO operational mode. The large antenna array can be used to create a large virtual antenna array. Advantageously, super-resolution algorithms can be used with the radar system, in particular the 4D radar system. In this way, a resolution of approximately 1° in azimuth and 2° in elevation can be achieved. This allows the radar system to produce a very dense point cloud for detections. On average, a non-HD radar system can achieve approximately 300-500 detections per frame. With the high-definition radar system approximately 20000-50000 detections per frame can be generated. A frame is an image of the field of view of the radar system obtained with a radar measurement.

Compared to non-HD radar systems, high-definition radar systems are better at resolving weaker targets e.g. pedestrians close to stronger targets e.g. cars. However the noise and false alerts are increased significantly compared to non-HD radar systems and need to be handled as well in the signal. The method according to the invention improves the identification of false alerts and thus improves the identification of targets of objects.

Advantageously, the invention can be used with vehicles, in particular motor vehicles. Advantageously, the invention can be used in land vehicles, in particular passenger cars, trucks, buses, motorcycles, drones, mobile robots or the like, aircraft, in particular flying drones, and/or water vehicles, in particular (under) water drones. The invention can also be applied to vehicles that can be operated autonomously or at least semi-autonomously. However, the invention is not limited to vehicles. It can also be used in stationary operation, robotics and/or machines, in particular construction or transport machines, such as cranes, excavators or the like.

The radar system may advantageously be connected to or be part of at least one control device of a vehicle, in particular a driver assistance system. In this way autonomous or partially autonomous operation of the vehicle can be enabled.

The at least one radar system can be used to detect stationary or moving objects, in particular vehicles, persons, animals, plants, obstacles, ground, roadways, roadway irregularities, in particular potholes or stones, roadway boundaries, (roadway) markings, (traffic) signs, open spaces, in particular parking spaces, precipitation or the like, and/or movements and/or gestures.

According to a favorable embodiment,
for at least a part of the detections corresponding to the at least one window a position spread factor and the Doppler spread factor can be determined, wherein the position spread factor characterizes a distribution of respective third position values and the Doppler spread factor characterizes a distribution of respective Doppler values of at least one part of the detections corresponding to the at least one two-dimensional window,
a power factor per detection each can be determined for at least a part of the detections corresponding to the at least one window, wherein each power factor is determined for the power value of the respective detection using a predetermined functional relation between power values and power factors, which is adapted by use of a mean power value and a power threshold, where the mean power value and the power threshold are determined from the power values of the at least one part of the detections corresponding to the at least one window,
the false alert probability can be determined for the at least one part of the detections corresponding to the at least one window based on the power factor and at least one of the spread factors for the respective detection each. With the spread factors, a density of detections within the at least one window can be estimated. The higher the density of the detections, the higher the probability of false alerts. The power factor characterizes the influence of echo signals causing the respective detection. A high power value is an indication that the respective detection is caused by an echo signal. A low power value is an indication that the respective detection is caused mainly by noise.

According to another favorable embodiment,
the position spread factor for the detections corresponding to at least one window can be determined as a combination, in particular a product, based on a maximum position distance and an average position distance between the third position values of detections corresponding to the at least one window
and
the Doppler spread factor for the detections corresponding to at least one window can be determined as a combination, in particular a product, based on a maximum Doppler distance and an average Doppler distance between the Doppler values of detections corresponding to the at least one window. In this way, the position spread factor and the Doppler spread factor can be determined by calculation.

The smaller the maximum distance, in particular the maximum position distance or the maximum Doppler distance, the higher is the concentration of detections. On the other hand, the smaller the average distance, in particular the average position distance or the average Doppler distance, the higher is the concentration of detections. The higher the concentration of detections the smaller is the probability of false alerts.

Advantageously, the maximum distance can be calculated as a difference between the respective values. In this way, simple calculation methods can be used.

According to another favorable embodiment,
the maximum position distance for the position spread factor can be determined as the difference between the smallest position value and the biggest position value of the detections corresponding to the at least one window,
and/or
the maximum Doppler distance for the Doppler spread factor can be determined as the difference between the smallest Doppler value and the biggest Doppler value of the detections corresponding to the at least one window,
and/or
the average position distance for the position spread factor can be determined as the quotient of the maximum position distance and the number of detections corresponding to the at least one window, where detections with identical position values can be considered as one detection for determining the number of detections
and/or
the average Doppler distance for the Doppler spread factor can be determined as the quotient of the maximum Doppler distance and the number of detections corresponding to the at least one window, where detections with identical Doppler values can be considered as one detection for determining the number of detections. In this way, the maximum distances and the average distances can be determined directly from the respective values, in particular the position values or the Doppler values.

According to another favorable embodiment
at least one of the spread factors, in particular the position spread factor and/or the Doppler spread factor, can be determined by combining, in particular multiplying, a respective maximum distance factor, in particular a maximum position distance factor or a maximum Doppler distance factor, with a respective average distance factor, in particular in particular an average position distance factor or an average Doppler distance factor,
wherein
at least one of the maximum distance factors, in particular the maximum position distance factor and/or the maximum Doppler distance factor, can be determined from the respective maximum distance, in particular the maximum position distance or the maximum Doppler distance, by means of a given functional relationship, in particular a functional relationship based on a Gaussian function, for maximum distances,
and/or
at least one of the average distance factors, in particular the average position distance factor and/or the average Doppler distance factor, can be determined from the respective average distance, in particular the average position distance or the average Doppler distance, by means of a given functional relationship, in particular a functional relationship based on a Gaussian function, for average distances. In this way, a respective influence of the position distance factors and the Doppler distance factors on the Doppler spread factor and the position spread factor can be adjusted individually.

Extensive research has shown that a functional relationship between the maximum distances, the average distances and the distance factors based on a Gaussian function gives very good results.

According to another favorable embodiment,
the smaller of the two spread factors, the position spread factor or the Doppler spread factor, can be used for the determination of the false alert probability and/or
the false alert probability per detection can be determined by combining, in particular multiplying, at least one of the spread factors, in particular the position spread factor and/or the Doppler spread factor, and the power factor for respective detection.

Advantageously, the smaller of the two spread factors, the position spread factor or the Doppler spread factor, can be used for the determination of the false alert probability. In this way, the lower limit for the false alert probability can be determined. This avoids overlooking detections of targets. The smaller the spread factor the smaller the false alert probability.

According to another favorable embodiment,
the power threshold can be determined from at least a part of the power values of the respective detections by use of statistical methods, in particular the power threshold can be calculated as sum of the third quartile range and 2 times an interquartile range of the group of power values,
and/or
the mean power value can be determined as average of the power values of the respective detections
and/or
the power factor can be determined from the mean power value and the power threshold by interpolation using the predefined functional relationship between power values and power factors, in particular by linear interpolation.

Advantageously, the power threshold can be determined from at least a part of the power values of the respective detections by use of statistical methods, in particular the power threshold can be calculated as sum of the third quartile range and 2 times an interquartile range of the group of power values. In this way, a power threshold can be set based on statistics, depending on the number of detections for which a false alert can be assumed.

Alternatively or additionally, the mean power value advantageously can be determined as average of the power values of the respective detections. In this way, the mean power value can be calculated from the power values of the respective detections.

Alternatively or additionally, the power factor advantageously can be determined from the mean power value and the power threshold by interpolation using the predefined functional relationship between power values and power factors, in particular by linear interpolation. With the mean power value and the power threshold, two functional function values can be specified for the predefined functional relation. Extensive research has shown, that a linear relationship gives good results.

According to another favorable embodiment, an initial two-dimensional window is defined and the respective false alert probabilities can be determined for the detections in the initial window, then the two-dimensional window can be moved in the domain described by the two of the three position values for determining respective false alert probabilities in different scan positions of the two-dimensional window. In this way, successively the whole domain described by the two of the three position values can be scanned with the window and respective false alert probabilities can be determined.

Further, the objective of the invention is solved by the method for the detection of targets by that the method for detection of targets comprises carrying out the method according to the invention for providing false alert information.

According to the invention, for at least a part of the detections each a false alert probability is determined as a false alert information by use of respective detection data sets of the detections, wherein the respective detection data set of each detection comprises three position values characterizing a position in a three-dimensional field of view of the radar system, a power value characterizing a power of received signals of the respective detection and a Doppler value. With the method for providing false alert information at least one two-dimensional window is defined in a domain described by two of the three position values of the detection data sets. For at least a part of the detections whose respective two position values corresponding to the domain having the window are within the at least one window, a respective false alert probability is determined based on the position values, Doppler values and power values at least of the part of the detections within the window. In this way, the providing false alert information for detections obtained by performing radar measurements can be improved.

Furthermore, the objective of the invention is solved by the radar system in that the radar system comprises at least a part of means for carrying out a method according to the invention for providing false alert information for detections obtained with the radar system.

Means for carrying out a method for providing false alert information can comprise means for determining false alert probabilities for detections as a false alert information by use of respective detection data sets of the detections, wherein the respective detection data set of each detection can comprise three position values characterizing a position in a three-dimensional field of view of the radar system, a power value characterizing an intensity of received signals of the respective detection and a Doppler value.

Further, the means for carrying out the method for providing false alert information can comprise means for defining two-dimensional windows in a domain described by two of the three position values of the detection data sets.

Furthermore, the means for carrying out the method for providing false alert information can comprise means for determining respective false alert probabilities for detections whose respective two position values corresponding to the domain having the window are within the window on the position values, Doppler values and power values at least of the detections within the window.

In this way, the provision of false alert information for detections obtained by performing radar measurements can be improved.

At least a part of the means for carrying out the method according to the invention can be realized by software. In this way, in particular flow charts, programs, algorithms and the like for carrying out the method can be used. Additionally or alternatively, at least a part of the means for carrying out the method according to the invention can be realized by hardware.

Moreover, the objective of the invention is solved with the driver assistance system in that the driver assistance system comprises at least a part of means for carrying out a method according to the invention for providing false alert information for detections obtained with the radar system.

According to the invention, the driver assistance system comprises at least one radar system, in particular at least one radar system according to the invention. Advantageously, at least one radar system of the driver assistance system, in particular of the driver assistance system according to the invention, can comprise at least a part of means for carrying out the method according to the invention. Since the at least one radar system is part of the driver assistance system, the means of the at least one radar system are thus also part of the driver assistance system. This applies analogously with respect to means of the vehicle, which has at least one driver assistance system and/or at least one radar system.

Further, the objective of the invention is solved with the vehicle in that the vehicle comprises at least a part of means for carrying out a method according to the invention for providing false alert information for detections obtained with the radar system.

The vehicle comprises at least one radar system. With the at least one radar system, an environment of the vehicle can be monitored.

Advantageously, the vehicle can comprise at least one driver assistance system. With the at least one driver assistance system the vehicle can be operated autonomously or semi-autonomously.

Advantageously, at least one radar system can be part of or connected to at least one driver assistance system. In this way information acquired with the at least one radar system can be transmitted to a control device of the at least one driver assistance system. With the at least one driver assistance system information obtained from the at least one radar system can be used for operating the vehicle autonomously or semi-autonomously.

Additionally or alternatively, at least a part of the means for performing the method according to the invention can be realized separately from the at least one radar system, for example with a control device of the vehicle and/or a control device of the driver assistance system.

Otherwise, the features and advantages shown in connection with the method according to the invention for providing false alert information, the method according to the invention for detection of targets, the radar system according to the invention, the driver assistance system according to the invention and the vehicle according to the invention and their respective advantageous configurations shall apply mutatis mutandis to each other and vice versa. The individual features and advantages can, of course, be combined with each other, whereby further advantageous effects can occur which go beyond the sum of the individual effects.

### BRIEF DESCRIPTION OF DRAWINGS

The present invention together with the above-mentioned and other objects and advantages may best be understood from the following detailed description of the embodiments, but not restricted to the embodiments, wherein is shown schematically

FIG. 1 a front view of a vehicle comprising a driver assistance system with a radar system;

FIG. 2 a top view of the vehicle from FIG. 1;

FIG. 3 a side view of the vehicle from FIGS. 1 and 2;

FIG. 4 a functional representation of the driver assistance system with the radar system of the vehicle from FIGS. 1 to 3;

FIG. 5 a flowchart of a method for detection of targets performed with the radar system from FIGS. 1 to 4, comprising a process section including a method for providing false alert information for detections obtained by performing radar measurements using the radar system;

FIG. 6 a flowchart of the process section comprising the method for providing false alert information from FIG. 5;

FIG. 7 an azimuth-elevation-range diagram with one exemplary azimuth-elevation-range bin with two exemplary detections obtained from radar measurements with the radar system from FIGS. 1 to 4;

FIG. 8 an azimuth-elevation-range diagram according to the diagram in FIG. 7, with a box of interest based on a window in the azimuth-range domain;

FIG. 9 a Doppler-elevation diagram with multiple detections based on one single object which is detected by a radar measurement using the radar system from FIGS. 1 to 5;

FIG. 10 a Doppler-elevation diagram with multiple detections based on two objects detected by a radar measurement using the radar system from FIGS. 1 to 5;

FIGS. 11 to 13 Doppler-elevation diagrams each having multiple detections, where some of the detections of each diagram are based on objects detected by a radar measurement using the radar system from FIGS. 1 to 5 and some of detections are false alerts;

FIG. 14 a diagram with the relation between maximum distances and maximum distance factors and the relation between average distances and average distance factors for the elevation values of detections obtained with the radar system;

FIG. 15 a diagram with the relation between the maximum distance factors and the average distance factors of FIG. 14, and a spread factor for the elevation values;

FIG. 16 a diagram with the relation between elevation values, Doppler values and power values of detections obtained with the radar system;

FIG. 17 a diagram with the relation between the power values of detections obtained with the radar system and power factors.

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

### EMBODIMENT(S) OF INVENTION

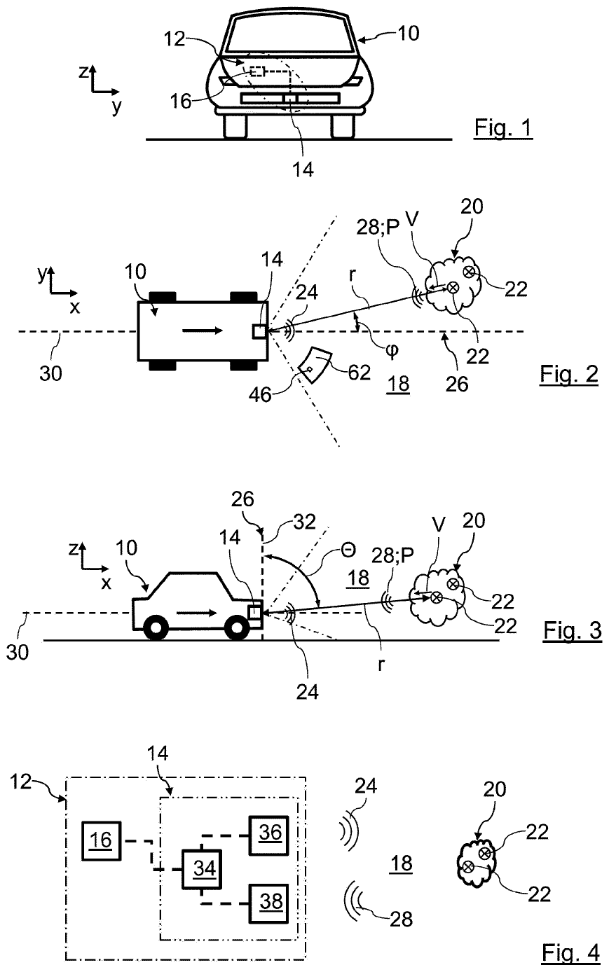

FIG. 1 shows a front view of a vehicle 10 in the form of a passenger car. FIG. 2 shows the vehicle 10 in a top view and FIG. 3 shows the vehicle 10 in a side view.

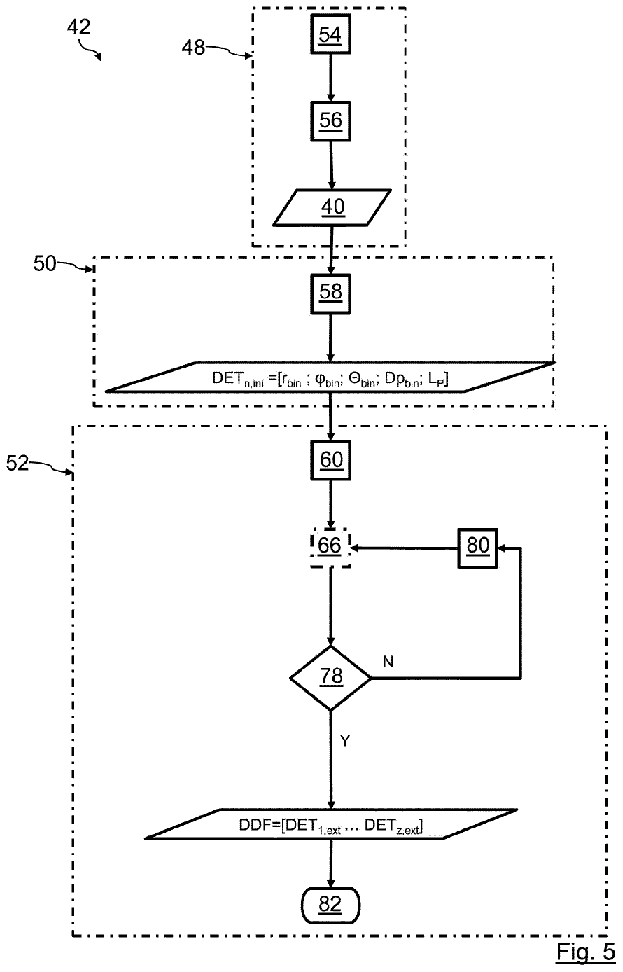

The vehicle 10 comprises a driver assistance system 12. FIG. 4 shows a functional diagram of the driver assistance system 12. With the driver assistance system 12 the vehicle 10 can be operated semi-autonomously or autonomously.

The driver assistance system 12 comprises a radar system 14 and a control unit 16. With the radar system 14 an environment in front of the vehicle 10 can be monitored. The radar system 14 is connected to the control unit 16 so that data about the environment collected by the radar system 14 can be transmitted to the control unit 16. With the control unit 16 of the driver assistance system 12, operational functions of the vehicle 10 can be controlled on basis of the information obtained by the radar system 14.

The radar system 14 is exemplarily located in the front area of the vehicle 10, for example in the front bumper. The radar system 14 can be used to monitor a field of view 18 in front of the vehicle 10 in the direction of travel, for example for objects 20. In the FIGS. 2 to 4, an object 20 is shown as an example. The radar system 14 can also be arranged in a different position on the vehicle 10 and can be oriented differently. Several radar systems 14 can also be provided.

The radar system 14 can detect targets 22 of stationary or moving objects 20, for example vehicles, persons, animals, plants, obstacles, the ground, roadways, roadway irregularities, for example potholes or stones, roadway boundaries, (traffic) signs, signals, free spaces, for example parking spaces, precipitation or the like.

A target 22 in the sense of the invention is an area or a reflection point of an object 20 from which radar signals 24 can be reflected. An object 20 can have one or more such targets 22. If the object 20 has several targets 22, radar signals 24 can also be reflected differently from these, for example in different directions. Targets 22 detected with the radar system 14 may be referred to as detected targets 22 for easier distinction. In FIGS. 2 to 4, only two targets 22 of the object 20 are shown as examples for the sake of clarity.

With the radar system 14, positions, for example directions like azimuth Φ and elevation θ and ranges r, and velocities v of objects 20 relative to a reference system 26 of the vehicle 10 can be determined. Further, the power P of echo signals 28 reflected from targets 22 can be determined.

The reference system 26 is a spherical coordinate system, for example. Azimuth Φ and elevation θ serve as direction information to characterize the directions of detected targets 22. With the direction information and the range r, a position of a target 22 relative to the reference system 26 can be specified. The origin of the spherical coordinate system is located at the intersection of the longitudinal axis 30 of the vehicle 10 and the vertical axis 32 of the vehicle 10, for example. The azimuth Φ=0° is on the longitudinal axis 30 of the vehicle 10.

The radar system 14 is designed as a multiple-input multiple-output (MIMO) high-definition (HD) four-dimensional (4D) radar. The radar system 14 comprises a control and evaluation device 34, a transmit antenna array 36 with multiple transmit antenna elements for transmitting electromagnetic radar signals 24 and a receiving antenna array 38 with multiple receiving antenna elements for receiving electromagnetic echo signals 28.

The transmit antenna elements and the receiving antenna elements generate a virtual antenna array with multiple virtual antenna elements for receiving echo signals 28 during a multiple-input multiple-output operation of the radar system 14.

Further, the control and evaluation device 34 comprises means for converting received antenna signals comprising electromagnetic echo signals 28, for example, into received signal 40 suitable for signal processing, for example suitable for processing with a method 42 for detection of targets 22 shown in FIG. 5.

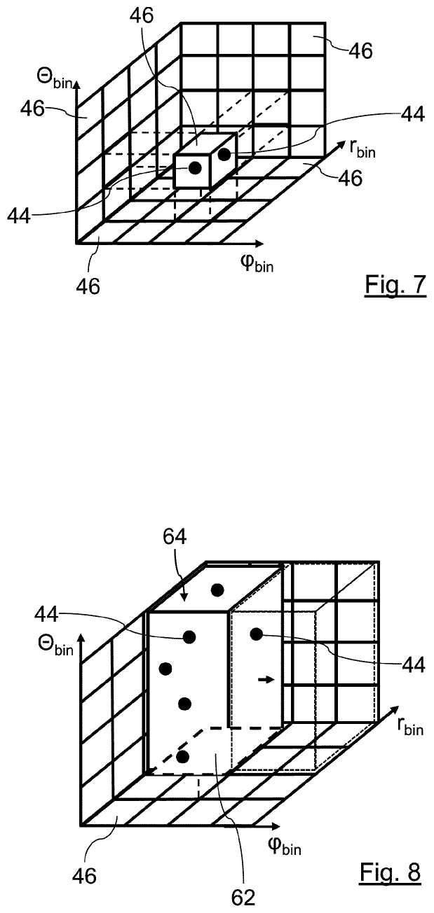

The control and evaluation device 34 comprises means for performing two-dimensional fast Fourier transforms for determining a respective detection data set DETₙ for each detection 44 from received signal 40. Some detections 44 are indicated in FIGS. 7 to 13, for example.

A detection 44 is a signal on the receiving side of the radar system 14. A detection 44 may be caused by echo signals 28 reflected from targets 22. Detections 44 also may be caused at least in part by noise. Thus, not every detection 44 necessarily gives information about a target 22 in the field of view 18 of the radar system 14. Detections 44 that are not caused by reflected echo signals 28 are so-called “false alerts”.

Furthermore, the control and evaluation device 34 comprises means for determining the detection data sets DETₙ. The respective detection data set DETₙ of each detection 44 comprises three position values, e.g. two direction values, namely the azimuth value Φ_{bin} and the elevation value θ_{bin}, and one range value r_{bin}, a Doppler value DP_{bin} and a power value L_{P}. For example, the detection data sets DETₙ have the form:

$$D E {T}_{n} = [ {Φ}_{bin} , {θ}_{bin} , {r}_{bin} , {DP}_{b i n} , {L}_{P} ]$$

where n is a control variable specifying the individual detection data set DETₙ.

The azimuth value Φ_{bin}, the elevation value θ_{bin} and the range value r_{bin} characterize a position in the three-dimensional field of view 18 of the radar system 14. The Doppler value DP_{bin} characterizes a velocity of a potential target 22 relative to the radar system 14. The power value L_{P} characterizes the intensity of received signals 40 of the respective detection 44

The azimuth value Φ_{bin}, the elevation value θ_{bin}, the range value r_{bin} and the Doppler value DP_{bin} indicate so-called bins 46, namely azimuth bins, elevation bins, range bins and Doppler bins. Some bins 46 are indicated in FIGS. 7 to 13, for example. The azimuth value Φ_{bin}, the elevation value θ_{bin}, the range value r_{bin} and the Doppler value DP_{bin} are specified as individual numbers, for example. The power value L_{P} is specified as a level of power in decibel, for example. FIG. 7 shows a detail of the azimuth-elevation-range domain with an azimuth-elevation-range bin 46 indicated as a cube as an example. Some exemplary detections 44 with the azimuth value Φ_{bin}, the elevation value θ_{bin} and the range value r_{bin} of the depicted azimuth-elevation-range bin 46 are indicated as black dots each.

At least parts of the means for carrying out the method 42 for detection of targets 22 can be realized by software. In a storage medium of the control and evaluation device 34, for example flow charts, e.g. programs, algorithms and/or implementation tables for carrying out the method 42 may be stored.

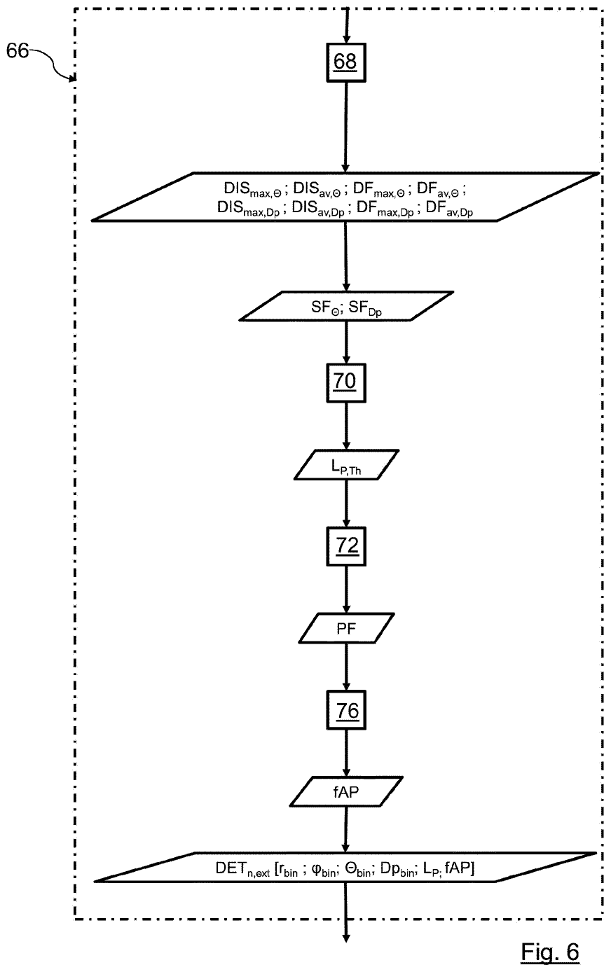

The method 42 for detection of targets 22 with the radar system 14 is described in more detail below using the flowcharts in FIGS. 5 and 6.

The method 42 comprises a radar measurement process 48, a determination process 50 for determination of detection data sets DETₙ and a method 52 for estimation false alert probabilities fAP for detections 44.

In the radar measurement process 48 a radar measurement is carried out with the radar system 14.

In a sending step 54 of the radar measurement process 48, radar signals 24 are transmitted with the transmit antenna elements according to a MIMO mode of operation. The transmit antenna elements and the receiving antenna elements create the virtual antenna array with multiple virtual antenna elements during the MIMO mode of operation.

If an object 20 is present in the field of view 18 of the radar system 14, the radar signals 24 are reflected at the targets 22 of the object 20.

In a receiving and conversion step 56 electromagnetic echo signals 28 resulting from the radar signal 24 reflected from the targets 22 are received by the virtual antenna elements. On the receiving side, electrical received signals 40 are generated, possibly caused by corresponding echo signals 28 and noise.

In a process step 58 of the determination process 50, the received echo signals 28 are converted into initial detection data sets DET_{n,ini} each for one detection 44. Each initial detection data sets DET_{n,ini} comprises the values characterizing one potential detection 44. The designation “initial” and the index “ini” are used to distinguish the initial detection data sets DET_{n,ini} from extended detection data sets DET_{n,ext} with the index “ext” which is explained below. Each initial detection data set DET_{n,ini} comprises the respective azimuth value Φ_{bin}, the respective elevation value θ_{bin}, the respective range value r_{bin}, the respective Doppler value DP_{bin} and the respective power value L_{P}.

With the radar system 14 thousands of detections 44, for example 20,000 to 50,000 detections 44, can be determined. Not all of the detections 44 are caused by echo signals 28 reflected from real targets 22. Those detections 44 that are not caused by echo signals 28 must be identified as false alerts. To do this, for each detection 44, a corresponding false alert probability fAP is determined using the following method 52 for estimation of false alert probability fAP.

In a first step 60 of the method 52 for estimation of false alert probability fAP an initial two-dimensional window 62 is defined in the azimuth-range domain. In FIG. 8, for example a box of interest 64 based on the initial two-dimensional window 62 is shown in the azimuth-elevation-range domain. The two-dimensional window 62 in the azimuth-range domain is described by the azimuth values Φ_{bin} and the range values r_{bin} of the initial detection data sets DET_{n,ini}. The box of interest 64 includes all detections 44 whose azimuth values θ_{bin} and range values r_{bin} are in the window 62, regardless of the respective elevation value θ_{bin}. In azimuth direction and in range direction the window 62 each extends over 35 bins, for example. For clarity, the window 62 shown in FIG. 8 extends only over two bins at a time. The box of interest 64 extends over all bins characterizing the field of view 18 of the radar system 14 in elevation direction.

FIG. 2 shows an area in the field of view 18 of the radar system 14 corresponding to an exemplary window 62. An area corresponding to a azimuth-range bin 46 in the window 62 shown is also indicated.

After the first step 60, the false alert probabilities fAP for the detections 44 of the current window 62 are determined in a process section 66 detailed in FIG. 6.

In a first step 68 of the process section 66 a Doppler spread factor SF_{DP} and an elevation spread factor SF_{θ} are determined based on all detections 44 of the current window 62.

The elevation spread factor SF_{θ} characterizes a distribution of the respective elevation values θ_{bin} of the detections 44 corresponding to the current window 62. The Doppler spread factor SF_{DP} characterizes a distribution of respective Doppler values DP_{bin} of the detections 44 corresponding to the current window 62.

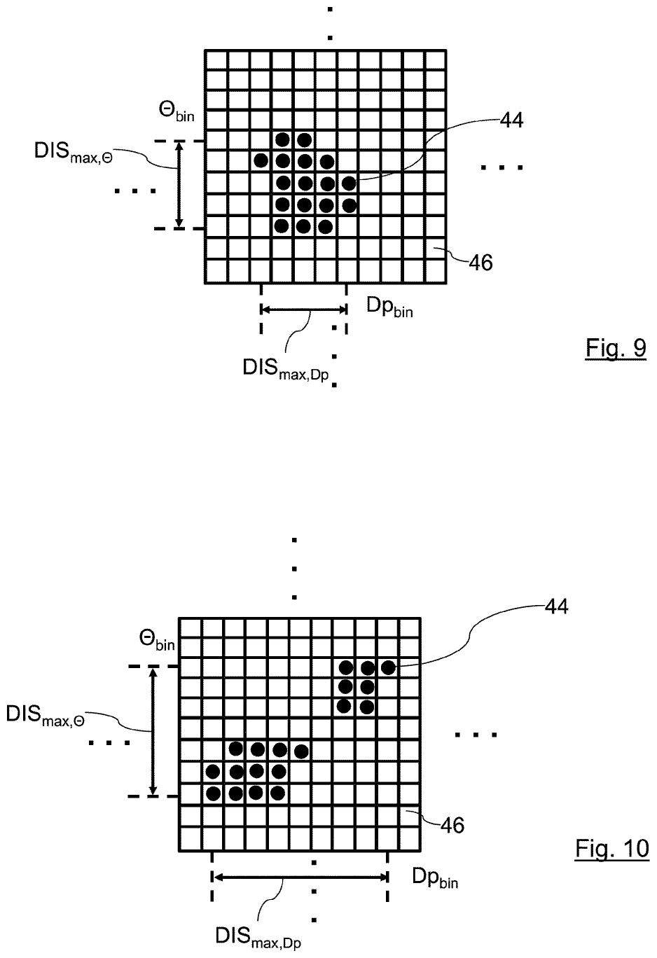

Multiple detections 44 originating from a single object 20 should be concentrated in the Doppler-elevation domain. FIG. 9 shows the detections 44 of targets 22 of a single object 20 in the Doppler-elevation domain with no false alerts. Multiple objects 20 can also be present at the same range-azimuth location, but they should be resolved in the Doppler-elevation domain. FIG. 10 shows the detections 44 of targets 22 of two objects 20 in the Doppler-elevation domain with no false alerts.

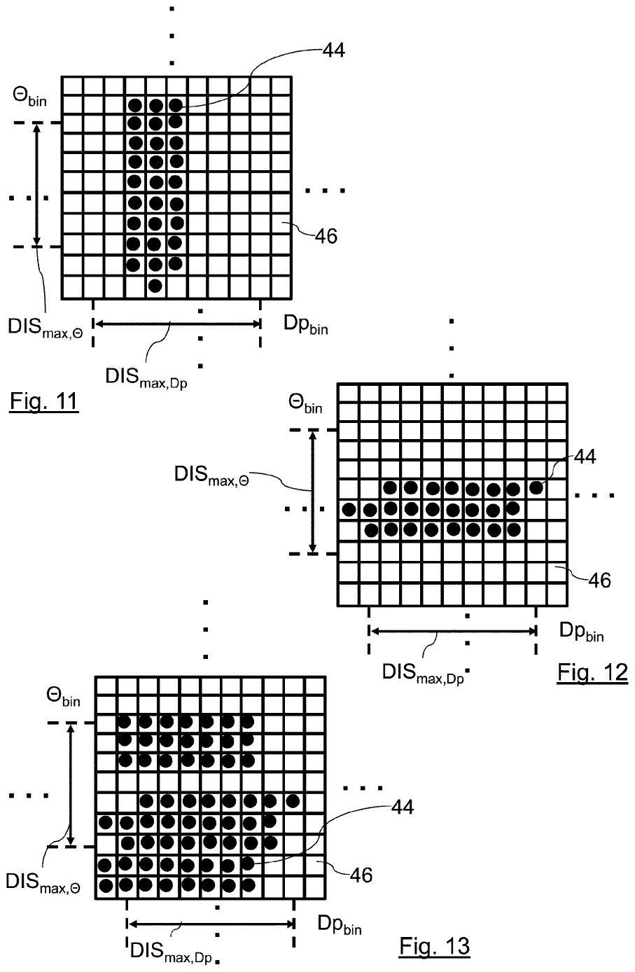

If a certain area in the field of view 18 of the radar system 14 has multiple targets 22 at all the possible elevation bins and/or Doppler bins, the respective detections 44 should be considered false alert with high probability. In FIGS. 11 to 13 examples are shown where detections 44 are spread over the Doppler-elevation domain, where some of the detections 44 can be classified as false alert using the method 52 described.

The elevation spread factor SF_{θ} is determined as a product of a maximum elevation distance factor DF_{max,θ} and an average elevation distance factor DF_{av,θ} between the elevation values θ_{bin} of detections 44 corresponding to the current window 62. The maximum elevation distance factor DF_{max,θ} and an average elevation distance factor DF_{av,θ} are depicted in FIG. 14.

FIG. 14 shows a relationship RELₘₐₓ between a maximum elevation distance DIS_{max,θ} and the maximum elevation distance factor DF_{max,θ}, and a relationship RELₐᵥ between an average elevation distance DIS_{av,θ} and the average distance factor DF_{av,θ}.

The maximum elevation distance DIS_{max,θ} for the elevation spread factor SF_{θ} is determined as the difference between the smallest elevation value θ_{bin} and the biggest elevation value θ_{bin} of the detections 44 corresponding to the current window 62.

The average elevation distance DIS_{av,θ} for the elevation spread factor SF_{θ} is determined as the quotient of the maximum elevation distance DIS_{max,θ} and the number of detections 44 corresponding to the current window 62. Thereby, detections 44 with identical elevation values θ_{bin} are considered as one detection 44 for determining the number of detections 44.

In the example shown in FIG. 9, the maximum elevation distance DIS_{max,θ} is 4. The number of respective detections 44 in the current window 62 with different elevation values θ_{bin} is 5. Thus, the average elevation distance DIS_{av,θ} is 4/5.

The maximum elevation distance factor DF_{max,θ} is determined from the maximum elevation distance DIS_{max,θ} by means of the given functional relationship RELₘₐₓ for maximum distances. The functional relationship RELₘₐₓ is based on a Gaussian function as an example.

FIG. 14 shows the normalized relationship between the maximum elevation distance DIS_{max,θ} and the maximum elevation distance factor DF_{max,θ}. The maximum elevation distance factor DF_{max,θ} has its maximum with the biggest maximum elevation distance DIS_{max,θ} in the current window 62, e.g. at a maximum elevation distance DIS_{max,θ} of 32 bins.

The average elevation distance factor DF_{av,θ} is determined from the average elevation distance DIS_{av,θ} by means of the given functional relationship RELₐᵥ for average distances. The functional relationship RELₐᵥ for average distances is based on a Gaussian function as an example.

FIG. 14 shows the normalized relationship between the average elevation distance DIS_{av,θ} and the average elevation distance factor DF_{av,θ}. The average elevation distance factor DF_{av,θ} has its maximum with the smallest average elevation distance DIS_{av,θ} in the current window 62, e.g. at an average elevation distance DIS_{av,θ} of 2 bins.

The smaller the maximum elevation distance DIS_{max,θ}, the higher is the concentration of detections 44. On the other hand, the smaller the average elevation distance DIS_{av,θ}, the higher is the concentration of detections 44. The higher the concentration of detections 44 the smaller is the probability of false alerts.

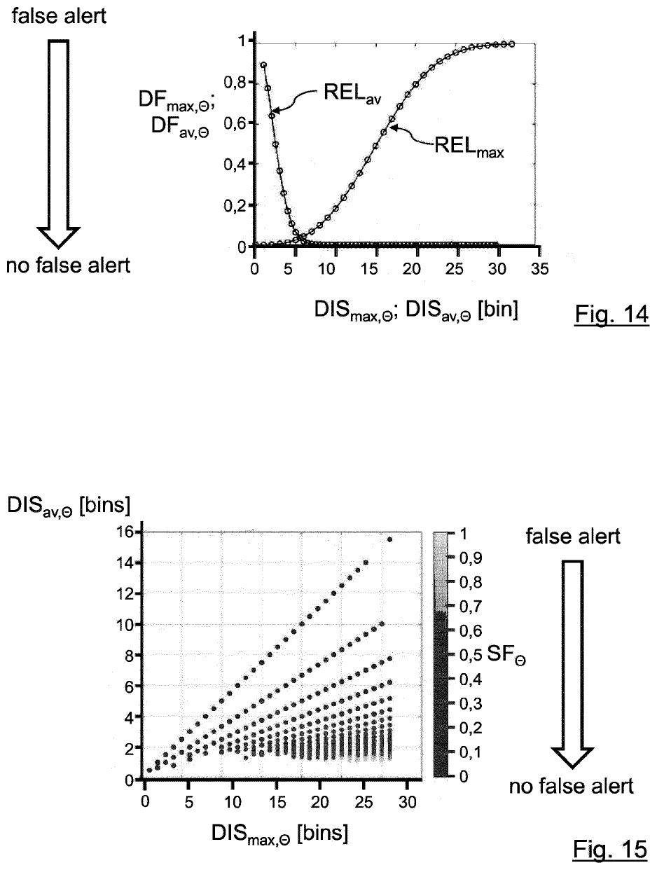

FIG. 15 shows the elevation spread factors SF_{θ} in relation to the maximum elevation distance DIS_{max,θ} and the average elevation distance DIS_{av,θ} in a grayscale representation.

Analogous to the elevation spread factors SF_{θ}, the Doppler spread factor SF_{Dp} is determined as a product of a maximum Doppler distance DIS_{max,Dp} and an average Doppler distance DIS_{av,Dp} between the Doppler values DP_{bin} of detections 44 corresponding to the current window 62.

The maximum Doppler distance DIS_{max,Dp} for the Doppler spread factor SF_{Dp} is determined as the difference between the smallest Doppler value DP_{bin} and the biggest Doppler value DP_{bin} of the detections 44 corresponding to the current window 62.

The average Doppler distance DIS_{av,Dp} for the Doppler spread factor SF_{Dp} is determined as the quotient of the maximum Doppler distance DIS_{max,Dp} and the number of detections 44 corresponding to the current window 62. Thereby, detections 44 with identical Doppler values DP_{bin} are considered as one detection 44 for determining the number of detections 44.

The Doppler spread factor SF_{Dp} is determined by multiplying a maximum Doppler distance factor DF_{max,Dp} with an average Doppler distance factor DF_{av,Dp}.

The maximum Doppler distance factor DF_{max,Dp} is determined from the maximum Doppler distance DIS_{max,Dp} by means of a given functional relationship for maximum distances. The functional relationship for maximum distances is based on a Gaussian function as an example.

The average Doppler distance factor DF_{av,Dp} is determined from the average Doppler distance DIS_{av,Dp} by means of a given functional relationship average distances. The functional relationship average distances is based on a Gaussian function as an example.

The smaller the maximum Doppler distance DIS_{max,Dp}, the higher is the concentration of detections 44. On the other hand, the smaller the average Doppler distance DIS_{av,Dp}, the higher is the concentration of detections 44. The higher the concentration of detections 44 the smaller is the probability of false alerts.

In a step 70, the power threshold L_{P,Th} is determined from the power values L_{P} of the detections 44 corresponding to the current window 62 by use of statistical methods. For example, the power threshold L_{P,Th} is calculated as sum of the third quartile range Q₃ and 2 times an interquartile range IQR of the group of power values L_{P} according to the following formula:

$${L}_{P , Th} = {Q}_{3} + 2 IQR$$

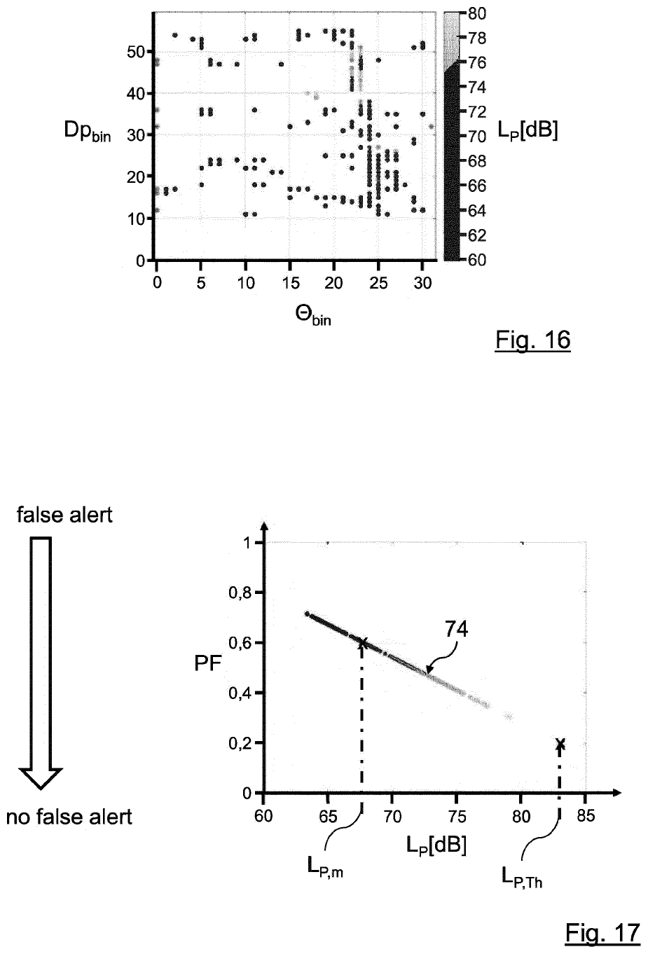

FIG. 16 shows a power spectrum for the detections 44 in the current window 62 in the Doppler-elevation domain as a grayscale representation. Power values L_{P} are defined in decibel according to a linear grayscale shown next to the power spectrum.

In a step 72, a power factor PF is determined from a mean power value L_{P,m} and the power threshold L_{P,Th} by interpolation using a predefined functional relation 74 between power values L_{P} and power factors PF. Extensive research has shown that a linear relation 74 between power values L_{P} and power factors PF, which is shown in FIG. 17, give the best results. So, the power factor PF is determined by linear interpolation from the mean power value L_{P,m} and the power threshold L_{P,Th}.

The mean power value L_{P,m} is determined as average of the power values L_{P} of the detections 44 corresponding to the current window 62.

FIG. 17 shows coordinate axes on which the relation 74 between power values L_{P} and power factors PF are plotted. The power values L_{P} in decibel are plotted on the abscissa axis, the power factors PF on the ordinate axis. The power factors PF are given as values between 0 and 1. The higher the power factor PF, the higher the false alert probability fAP.

To define the linear relation 74 between power values L_{P} and power factors PF, a power factor PF is assigned to each of the power threshold L_{P,Th} and mean power value L_{P,m}, which represent respective power values L_{P} each. In the example shown in FIG. 17 the power threshold L_{P,Th} is 83 dB. The power value L_{P}=0.2 is assigned to the power threshold L_{P,Th}. The mean power value L_{P,m} is 68 dB. The mean power value L_{P,m} is assigned the value 0.6 as the associated power factor PF.

In a step 76, the false alert probability fAP per detection 44 in the current window 62 is determined for each detection 44 by multiplying the smaller of the two spread factors, the elevation spread factor SF_{θ} or the Doppler spread factor SF_{DP}, and the power factor PF for that detection 44. An extended detection data set DET_{n,ext} for the respective detection 44 is formed based on the respective initial data set DET_{n,ini} which is extended with the respective false alert probability fAP.

The extended detection data sets DET_{n,ext} can have the following form:

$$DE {T}_{n} = [ {Φ}_{bin} , {θ}_{bin} , {r}_{bin} , {DP}_{b i n} , {L}_{P} , fAP ]$$

where n is the control variable specifying the individual extended detection data set DET_{n,ext} and “ext” stands for extended.

After completion of the process section 66, a decision step 78, shown in FIG. 5, checks whether all windows 62 in the azimuth-range domain have been considered for the determination of false alert probability fAP.

If not, in a next step 80 the next window 62 in the azimuth-range domain is defined and the process section 66 is repeated for the detections 44 in the new defined window 62. Thereby, the next window 62 is defined without overlapping the windows 62 defined in the previous passes. In this way, the entire azimuth-range domain characterizing the field of view 18 of the radar system 14 is scanned successively with corresponding windows 62.

If the decision step 78 results that all windows 62 in the azimuth-range domain have been considered, a detection data field DDF comprising the extended detection data DET_{n,ext} of all detections 44 obtained by the radar measurement is provided.

The detection data field DDF can have the following form:

$$DDF = [ {DET}_{1 , ext} … {DET}_{z , ext} ]$$

where z is the total number of detections 44.

After that, the method 52 for determination of false alert probability fAP for the detections 44 of the respective radar measurement is terminated in a step 82.

The data from the detection data field DDF can be used for further processing. For example the data from the detection data field DDF can be forwarded to the control unit 16 of the driver assistance system 12. In particular, the vehicle 10 can be operated autonomously or semi-autonomously on the basis of the data from the detection data field DDF.

The sequence of steps in the method 42 for detection of targets 22 can also be varied expediently. Steps can also be performed parallel.

1. A method for providing false alert information for detections obtained by performing at least one radar measurement using at least one radar system,
wherein for each of at least a part of the detections, a false alert probability is determined as a false alert information by use of respective detection data sets of the detections,
wherein the respective detection data set of each detection comprises three position values characterizing a position in a three-dimensional field of view of the radar system, a power value characterizing a power of received signals of the respective detection, and a Doppler value,
wherein at least one two-dimensional window is defined in a domain described by two of the three position values of the detection data sets, and
for at least a part of the detections whose respective two position values corresponding to the domain having the at least one two-dimensional window are within the at least one two-dimensional window, a respective false alert probability is determined based on the position values, Doppler values, and power values of at least of the part of the detections within the at least one two-dimensional window.

2. The method according to claim 1, wherein:
for at least a part of the detections corresponding to the at least one two-dimensional window a position spread factor and the Doppler spread factor are determined, wherein the position spread factor characterizes a distribution of respective third position values and the Doppler spread factor characterizes a distribution of respective Doppler values of at least one part of the detections corresponding to the at least one two-dimensional window,
a power factor per detection each is determined for at least a part of the detections corresponding to the at least one two-dimensional window, wherein each power factor is determined for the power value of the respective detection using a predetermined functional relation between power values and power factors, which is adapted by use of a mean power value and a power threshold, where the mean power value and the power threshold are determined from the power values of the at least one part of the detections corresponding to the at least one two-dimensional window, and
the false alert probability is determined for the at least one part of the detections corresponding to the at least one two-dimensional window based on the power factor and at least one of the spread factors for the respective detection each.

3. The method according to claim 2,
wherein the position spread factor for the detections corresponding to at least one two-dimensional window is determined as a combination based on a maximum position distance and an average position distance between the third position values of detections corresponding to the at least one two-dimensional window, and
wherein the Doppler spread factor for the detections corresponding to at least one two-dimensional window is determined as a combination based on a maximum Doppler distance and an average Doppler distance between the Doppler values of detections corresponding to the at least one two-dimensional window.

4. The method according to claim 3,
wherein the maximum position distance for the position spread factor is determined as the difference between the smallest position value and the biggest position value of the detections corresponding to the at least one two-dimensional window, and/or
the maximum Doppler distance for the Doppler spread factor is determined as the difference between the smallest Doppler value and the biggest Doppler value of the detections corresponding to the at least one two-dimensional window, and/or
the average position distance for the position spread factor is determined as the quotient of the maximum position distance and the number of detections corresponding to the at least one two-dimensional window, where detections with identical position values are considered as one detection for determining the number of detections, and/or
the average Doppler distance for the Doppler spread factor is determined as the quotient of the maximum Doppler distance and the number of detections corresponding to the at least one two-dimensional window, where detections with identical Doppler values are considered as one detection for determining the number of detections.

5. The method according to claim 3,
wherein at least one of the spread factors is determined by combining a respective maximum distance factor with a respective average distance factor
wherein at least one of the maximum distance factors is determined from the respective maximum distance by means of a given functional relationship for maximum distances, and/or
at least one of the average distance factors is determined from the respective average distance by means of a given functional relationship for average distances.

6. The method according to claim 2, wherein a smaller of the position spread factor or the Doppler spread factor is used for the determination of the false alert probability and/or the false alert probability per detection is determined by combining at least one of the spread factors for respective detection.

7. The method according to claim 2,
wherein the power threshold is determined from at least a part of the power values of the respective detections by use of statistical methods, and/or
the mean power value is determined as an average of the power values of the respective detections, and/or
the power factor is determined from the mean power value and the power threshold by interpolation using the predefined functional relationship between power values and power factors.

8. The method according to claim 1, wherein an initial two-dimensional window is defined and the respective false alert probabilities are determined for the detections in the initial two-dimensional window, then the initial two-dimensional window is moved in the domain described by the two of the three position values for determining respective false alert probabilities in different scan positions of the initial two-dimensional window.

9. A method for detection of targets by use of at least one radar system,
wherein at least one radar measurement is performed in which radar signals are transmitted and echo signals are received and converted into received signals,
wherein detection data for detections are determined by use of at least a part of the received signals,
wherein a method for providing false alert information for at least a part of the detections is performed,
wherein the method for detection of targets comprises carrying out the method according to claim 1 for providing false alert information.

10. A radar system comprising: means for performing a method for providing false alert information for detections obtained by radar measurements with the radar system,
wherein the radar system comprises at least a part of means for carrying out a method according to claim 1 for providing false alert information for detections obtained with the radar system.

11. A driver assistance system comprising:
at least one radar system; and
means for performing a method for providing false alert information for detections obtained by radar measurements with the at least one radar system,
wherein the driver assistance system comprises at least a part of means for carrying out a method according to claim 1 for providing false alert information for detections obtained with the radar system.

12. A vehicle comprising:
at least one radar system; and
means for performing a method for providing false alert information for detections obtained by radar measurements with the at least one radar system,
wherein the vehicle comprises at least a part of means for carrying out a method according to claim 1 for providing false alert information for detections obtained with the radar system.
